(19) United States
(12) Patent Application Publication
(10) Pub. No.: US 2024/0347229 A1
(43) Pub. Date: Oct. 17, 2024

(54) ELECTRICAL SIGNAL CABLE AND HYBRID CABLE

(71) Applicant: NITTO DENKO CORPORATION, Osaka (JP)

(72) Inventors: Koichi TSUDA, Osaka (JP); Kyohei INAMOTO, Osaka (JP); Naoyuki TANAKA, Osaka (JP); Hideharu KAJIZUKA, Kanagawa (JP); Takuya KOIZUMI, Kanagawa (JP)

(73) Assignees: NITTO DENKO CORPORATION, Osaka (JP); OKI ELECTRIC CABLE CO., LTD., Kanagawa (JP)

(21) Appl. No.: 18/631,853

(22) Filed: Apr. 10, 2024

(30) Foreign Application Priority Data
Apr. 12, 2023 (JP) 2023-065130

(51) Int. Cl. H01B 11/06; H01B 11/22

(52) U.S. Cl. CPC H01B 11/06; H01B 11/22

(57) ABSTRACT

A shield tape is provided in a hybrid cable. The shield tape includes one pair of differential wirings and a shield tape. The shield tape surrounds the one pair of differential wirings. The shield tape includes a substrate layer and a shield layer. The substrate layer has insulating properties. The shield layer is disposed at the opposite side of the one pair of differential wirings with respect to the substrate layer.

### CROSS-REFERENCE TO RELATED APPLICATION

The present application claims priority from Japanese Patent Application No. 2023-065130 filed on Apr. 12, 2023, the contents of which are hereby incorporated by reference into this application.

### TECHNICAL FIELD

The present invention relates to an electrical signal cable and a hybrid cable.

### BACKGROUND ART

A hybrid cable including an electrical signal cable is known (ref: for example, Patent Document 1). The hybrid cable of Patent Document 1 includes the electrical signal cable and a ground wiring. The electrical signal cable includes one pair of differential wirings and a shield tape. The one pair of differential wirings transmit electrical signals. The shield tape surrounds the one pair of differential wirings. The shield tape is grounded.

### CITATION LIST

### Patent Document

Patent Document 1: Japanese Unexamined Patent Publication No. 2019-169457

### SUMMARY OF THE INVENTION

### Problem to be Solved by the Invention

The shield tape includes an insulating substrate layer, and a shield layer disposed on an inner surface thereof. When the shield tape is attempted to be grounded, it is considered that the ground wiring is disposed so as to be in contact with the shield layer inside the shield tape. In this case, the ground wiring is adjacent to the one pair of differential wirings. Then, there is a problem that signals in the one pair of differential wirings are attenuated.

Further, there is also a demand to miniaturize the electrical signal cable.

The present invention provides an electrical signal cable and a hybrid cable which are able to reduce attenuation of signals, and to be miniaturized.

### Means for Solving the Problem

The present invention (1) includes an electrical signal cable provided in a hybrid cable including one pair of differential wirings for transmitting electrical signals, and a shield cord surrounding the one pair of differential wirings and including an insulating substrate layer and a shield layer disposed at the opposite side of the one pair of differential wirings with respect to the substrate layer.

In this electrical signal cable, the shield layer is disposed at the opposite side of the one pair of differential wirings with respect to the substrate layer. According to this configuration, it is possible to bring the shield layer into contact with a ground wiring, while providing the ground wiring outside the shield cord. That is, it is possible to dispose the ground wiring away from the one pair of differential wirings without providing the ground wiring inside the shield cord. Therefore, it is possible to suppress attenuation of signals in the one pair of differential wirings.

Further, since it is not necessary to provide the ground wiring inside the shield tape, it is possible to miniaturize the electrical signal cable.

The present invention (2) includes a hybrid cable including the electrical signal cable described in (1), and a ground wiring in contact with the shield layer in the electrical signal cable.

According to this hybrid cable, it is possible to reliably ground the shield layer.

The present invention (3) includes the hybrid cable described in (2), wherein the shield cord is a shield tape.

In this hybrid cable, it is possible to easily dispose the shield tape in the one pair of differential wirings.

The present invention (4) includes the hybrid cable described in (2) or (3), wherein the electrical signal cable and the ground wiring are twisted.

In this hybrid cable, since the electrical signal cable and the ground wiring are twisted, it is possible to reliably bring the shield tape of the electrical signal cable into contact with the ground wiring.

The present invention (5) includes the hybrid cable described in (4) further including an optical cable, and a sheath surrounding the electrical signal cable and the optical cable, wherein a twist pitch of the optical cable, the electrical signal cable, and the ground wiring is 5 mm or more and 150 mm or less.

According to this hybrid cable, since the twist pitch is 5 mm or more and 150 mm or less, it is possible to reduce pressure on the electrical signal cable by the ground wiring. Therefore, it is possible to suppress damage to the shield cord caused by entry of the ground wiring into the shield cord. Therefore, the electrical signal cable has excellent reliability of transmission.

### Effect of the Invention

An electrical signal cable and a hybrid cable of the present invention can be miniaturized, while reducing attenuation of signals.

### BRIEF DESCRIPTION OF THE DRAWINGS

FIG. 1 shows a cross-sectional view of a hybrid cable including one embodiment of an optical cable of the present invention.

FIG. 2 shows a perspective view for illustrating an embodiment in which a shield tape is wound around one pair of differential wirings.

FIG. 3 shows a perspective view for illustrating twist and a twist pitch of a hybrid cable.

### DESCRIPTION OF EMBODIMENTS

### 1. ONE EMBODIMENT

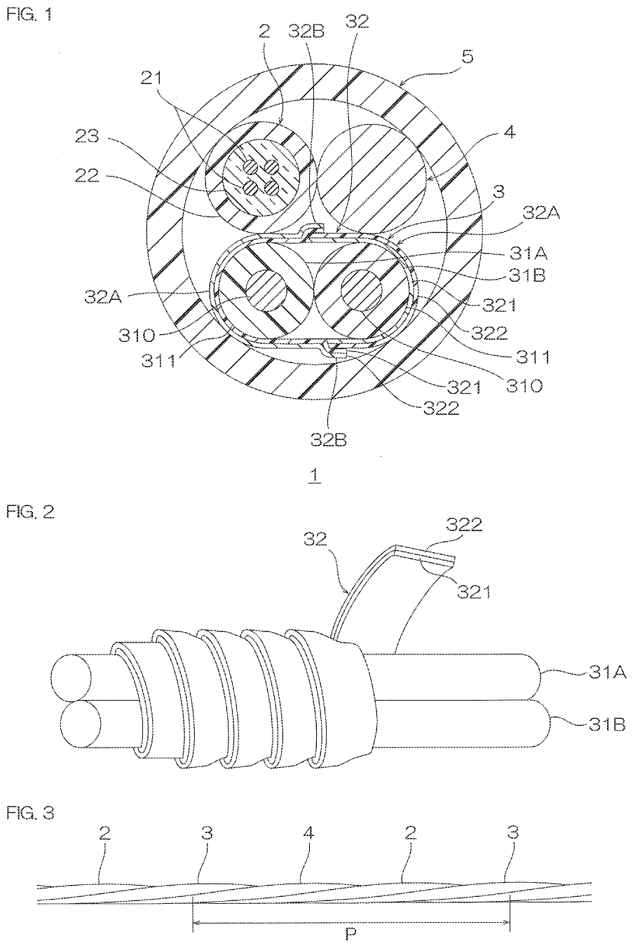

A hybrid cable including one embodiment of an electrical signal cable of the present invention is described with reference to FIGS. 1 to 3.

### 1.1 Hybrid Cable 1

A hybrid cable 1 has a generally circular shape in a cross-sectional view. The cross-sectional view is a view at a cross section orthogonal to a direction in which the hybrid cable 1 extends. In this embodiment, the hybrid cable 1 includes an optical cable 2, an electrical signal cable 3, a ground wiring 4, and a sheath 5.

### 1.2 Optical Cable 2

The optical cable 2 is disposed inside the hybrid cable 1. The optical cable 2 has the generally circular shape in the cross-sectional view. In this embodiment, the optical cable 2 includes a plurality of plastic optical fibers (POF) 21, a tube 22, and a fiber material 23.

### 1.2.1 Plastic Optical Fiber 21

Each of the plurality of plastic optical fibers 21 has the generally circular shape in the cross-sectional view. The plastic optical fiber 21 has flexibility. The plastic optical fiber 21 includes a core which is not shown, a clad which is not shown, and an over clad which is not shown in order outwardly in a radial direction. The clad is a single layer or a plurality of layers. The radial direction is included in the orthogonal direction described above. Examples of a material for the plastic optical fiber 21 include resins. Examples of the resin include acrylic resins and epoxy resins.

An outer diameter of the plastic optical fiber 21 is, for example, 0.05 mm or more, preferably 0.15 mm or more, and for example, 0.50 mm or less, preferably 0.35 mm or less.

The number of plastic optical fibers 21 is, for example, 2 or more, for example, 3 or more, and for example, 8 or less, preferably 6 or less.

### 1.2.2 Tube 22

The tube 22 surrounds the plurality of plastic optical fibers 21. In this embodiment, the tube 22 has a generally annular shape in the cross-sectional view. The tube 22 may be also referred to as an optical cord.

Examples of the material for the tube 22 include resins. Examples of the resin include acrylic resins, epoxy resins, polyimide resins, and ionomer resins. Preferably, from the viewpoint of processability and handleability, an ionomer resin is used.

The outer diameter of the tube 22 is, for example, 0.3 mm or more, preferably 1.0 mm or more, and for example, 5.0 mm or less, preferably 2.0 mm or less. A thickness of the tube 22 is, for example, 0.02 mm or more, preferably 0.1 mm or more, and for example, 0.5 mm or less, preferably 0.3 mm or less.

### 1.2.3 Fiber Material 23

The fiber material 23 covers the surfaces of the plurality of plastic optical fibers 21 inside the tube 22. The fiber material 23 fills the tube 22. Examples of the material for the fiber material 23 include aramid resins.

### 1.3 Electrical Signal Cable 3

The electrical signal cable 3 is disposed inside the hybrid cable 1. The electrical signal cable 3 is adjacent to the optical cable 2 in the cross-sectional view. The electrical signal cable 3 has an elliptical shape or the circular shape in the cross-sectional view. The electrical signal cable 3 includes one pair of differential wirings 31A and 31B, and a shield tape 32 as one example of a shield cord.

### 1.3.1 One Pair of Differential Wirings 31A and 31B

The one pair of differential wirings 31A and 31B are disposed inside the electrical signal cable 3. Each of the one pair of differential wirings 31A and 31B has the circular shape in the cross-sectional view. The one pair of differential wirings 31A and 31B are adjacent to each other in the cross-sectional view. The one pair of differential wirings 31A and 31B are one pair of signal wirings. Each of the one pair of differential wirings 31A and 31B transmits electrical a signal. The one pair of differential wirings 31A and 31B have the same configuration. Specifically, each of the one pair of differential wirings 31A and 31B includes a core wiring 310 and a covering material 311 in order outwardly in the radial direction.

The core wiring 310 has the circular shape in the cross-sectional view. An example of the material for the core wiring 310 includes copper. The outer diameter of the core wiring 310 is, for example, 0.01 mm or more, preferably 0.1 mm or more, and for example, 2.5 mm or less, preferably 0.5 mm or less.

The covering material 311 is disposed on a peripheral surface of the core wiring 310. The covering material 311 covers the core wiring 310. Examples of the material for the covering material 311 include resins. The thickness of the covering material 311 is, for example, 0.05 mm or more, preferably 0.1 mm or more, and for example, 0.25 mm or less, preferably 0.2 mm or less, more preferably 0.15 mm. When the thickness of the covering material 311 is the above-described upper limit or less, it is possible to miniaturize the electrical signal cable 3.

The outer diameter of each of the one pair of differential wirings 31A and 31B is, for example, 0.02 mm or more, preferably 0.2 mm or more, and for example, 1.0 mm or less, preferably 0.85 mm or less. When the outer diameter of each of the one pair of differential wirings 31A and 31B is the above-described upper limit or less, it is possible to miniaturize the electrical signal cable 3.

### 1.3.2 Shield Tape 32

The shield tape 32 surrounds the one pair of differential wirings 31A and 31B. The shield tape 32 is disposed at the outermost portion of the electrical signal cable 3. The shield tape 32 has an elliptical annular shape or the annular shape in the cross-sectional view. As shown in FIG. 2, the shield tape 32 has a predetermined width, and is wound spirally around the one pair of differential wirings 31A and 31B.

The shield tape 32 includes a substrate layer 321 and a shield layer 322 in order outwardly in the radial direction. Specifically, the substrate layer 321 and the shield layer 322 are disposed in order outwardly in the radial direction in a state where the shield tape 32 is wound spirally around the one pair of differential wirings 31A and 31B described above.

### 1.3.2.1 Substrate Layer 321

The substrate layer 321 is disposed inside (at the side of the one pair of differential wirings 31A and 31B of) the shield tape 32. That is, the substrate layer 321 faces the inside in the radial direction. The substrate layer 321 is in contact with outer peripheral surfaces of the one pair of differential wirings 31A and 31B. The substrate layer 321 has insulating properties. The insulating substrate layer 321 refers to a substrate layer which is less susceptible to flow of electricity. In this embodiment, electrical conductivity of the insulating substrate layer 321 is, for example, 1.0×10⁻¹¹ S/m or less, preferably 5.0×10⁻¹² S/m or less, and for example, 1.0×10⁻¹³ S/m or more.

The substrate layer 321 has the flexibility. The substrate layer 321 is the single layer or the plurality of layers. An adhesive which is not shown may be also present on an inner surface of the substrate layer 321 in the radial direction.

Examples of the material for the substrate layer 321 include resins. Examples of the resin include polyester resins, polyolefin resins, polyimide resins, and rubber. As the resin, from the viewpoint of the processability, preferably, a polyester resin is used. Examples of the polyester resin include polyethylene terephthalate (PET), polybutylene terephthalate (PBT), and polyethylene naphthalate (PEN). As the polyester resin, from the viewpoint of the processability, preferably, a PET is used.

Relative dielectric constant at 1 GHz of the substrate layer 321 is, for example, 10 or less, preferably 5 or less, and for example, 1 or more.

The thickness of the substrate layer 321 is, for example, 0.005 mm or more, preferably 0.01 mm or more, and for example, 1 mm or less, preferably 0.5 mm or less. A ratio of the thickness of the substrate layer 321 to the thickness of the shield tape 32, that is, the thickness of the substrate layer 321/the thickness of the shield tape 32 is, for example, 0.2 or more, preferably 0.5 or more, and for example, 0.9 or less, preferably 0.7 or less. When the thickness of the substrate layer 321 and/or the ratio of the thickness of the substrate layer 321 are/is the above-described lower limit or more, it is possible to ensure strength of the shield tape 32, and to ensure reliability. When the thickness of the substrate layer 321 and/or the ratio of the thickness of the substrate layer 321 are/is the above-described upper limit or less, it is possible to miniaturize the shield tape 32.

### 1.3.2.2 Shield Layer 322

The shield layer 322 is disposed outside the substrate layer 321 in the radial direction. In other words, the shield layer 322 is disposed at the opposite side of the one pair of differential wirings 31A and 31B with respect to the substrate layer 321. The shield layer 322 is in contact with the entire outer surface of the substrate layer 321 in the radial direction. The shield layer 322 may be also in contact with a portion of the outer surface of the substrate layer 321, and the shield layer 322 may also cover the substrate layer 321. The shield layer 322 faces the outside in the radial direction in the state where the shield tape 32 is wound spirally around the one pair of differential wirings 31A and 31B described above. That is, the shield layer 322 faces the optical cable 2, the ground wiring 4, and the sheath 5. The shield layer 322 is in contact with at least the outer peripheral surface of the ground wiring 4. The shield layer 322 is electrically connected to the ground wiring 4. Thus, the shield layer 322 is grounded. In this embodiment, the shield layer 322 is in contact with each of the optical cable 2, the ground wiring 4, and the sheath 5.

Since the shield tape 32 is wound spirally around the one pair of differential wirings 31A and 31B, in this embodiment, the shield tape 32 includes a non-overlapped portion 32A and an overlapped portion 32B.

In the non-overlapped portion 32A, the shield tapes 32 are not overlapped with each other in the radial direction. In the non-overlapped portion 32A, only the substrate layer 321 and the shield layer 322 are disposed in order outwardly in the radial direction. Thus, in the non-overlapped portion 32A, the shield layer 322 can be brought into contact with the ground wiring 4 to be grounded.

In the overlapped portion 32B, the shield tapes 32 are overlapped with each other in the radial direction. Specifically, the substrate layer 321 in the shield tape 32 disposed outside in the radial direction is disposed on (i.e., in contact with) the outer surface of the shield layer 322 in the shield tape 32 disposed inside in the radial direction. Specifically, as for the shield tape 32, in the overlapped portion 32B, at least the substrate layer 321, the shield layer 322, the substrate layer 321, and the shield layer 322 are disposed in order outwardly in the radial direction (hereinafter, may be referred to as a doubled portion). In the above-described doubled portion, the shield layer 322 located at the outermost side in the radial direction also faces the outside in the radial direction. Thus, in the overlapped portion 32, the shield layer 322 can be brought into contact with the ground wiring 4 to be grounded.

Examples of the material for the shield layer 322 include metals. Examples of the metal include copper, iron, silver, gold, aluminum, nickel, and alloys of these (stainless steel, bronze). As the metal, from the viewpoint of the flexibility, preferably, aluminum is used.

The thickness of the shield layer 322 is, for example, 0.001 mm or more, preferably 0.005 mm or more, and for example, 0.1 mm or less, preferably 0.05 mm or less. The ratio of the thickness of the shield layer 322 to the thickness of the shield tape 32 is, for example, 0.05 or more, preferably 0.1 or more, and for example, 0.5 or less, preferably 0.2 or less. The ratio of the thickness of the shield layer 322 to the thickness of the substrate layer 321, that is, the thickness of the shield layer 322/the thickness of the substrate layer 321 is, for example, 0.1 or more, preferably 0.2 or more, and for example, 1 or less, preferably 0.5 or less. When the thickness of the shield layer 322 and the ratio of the thickness of the shield layer 322 are the above-described lower limit or more, it is possible to reliably ground the shield tape 32. When the thickness of the shield layer 322 and the ratio of the thickness of the shield layer 322 are the above-described upper limit or less, it is possible to make the shield tape 32 thin and miniaturize it.

### 1.4 Ground Wiring 4

The ground wiring 4 is disposed inside the hybrid cable 1. The ground wiring 4 is disposed adjacent to the optical cable 2 and the electrical signal cable 3. The outer peripheral surface of the ground wiring 4 is in contact with the shield layer 322 in the electrical signal cable 3. The ground wiring 4 has the circular shape in the cross-sectional view. Examples of the material for the ground wiring 4 include copper, iron, silver, gold, aluminum, nickel, and alloys of these (stainless steel, bronze), and preferably, aluminum and copper are used. The outer diameter of the ground wiring 4 is, for example, 0.1 mm or more, preferably 0.5 mm or more, and for example, 3 mm or less, preferably 2 mm or less.

### 1.5 Twist of Optical Cable 2, Electrical Signal Cable 3, and Ground Wiring 4

As shown in FIG. 3, the optical cable 2, the electrical signal cable 3, and the ground wiring 4 are twisted. Thus, it is possible to reliably bring the shield tape 32 of the electrical signal cable 3 into contact with the ground wiring 4. A double-headed arrow shown in FIG. 3 shows a twist pitch P.

The twist pitch P of the optical cable 2, the electrical signal cable 3, and the ground wiring 4 is, for example, 5 mm or more, preferably 10 mm or more. When the twist pitch P is the above-described lower limit or more, it is possible to reduce pressure on the electrical signal cable 3 by the ground wiring 4. Therefore, it is possible to suppress damage to the shield tape 32 caused by entry of the ground wiring 4 into the shield tape 32. As a result, the electrical signal cable 3 has the excellent reliability of transmission.

The twist pitch P of the optical cable 2, the electrical signal cable 3, and the ground wiring 4 is, for example, 1000 mm or less, preferably 150 mm or less, more preferably 100 mm or less. When the twist pitch P of the optical cable 2, the electrical signal cable 3, and the ground wiring 4 is the above-described upper limit or less, it is possible to reliably bring the shield tape 32 of the electrical signal cable 3 into contact with the ground wiring 4.

The twist pitch P is a distance in which the optical cable 2, the electrical signal cable 3, and the ground wiring 4 proceed in a direction in which the hybrid cable 1 extends when each of the optical cable 2, the electrical signal cable 3, and the ground wiring 4 rotates once (i.e., rotates at 360 degrees).

### 1.6 Sheath 5

The sheath 5 is the outermost layer in the hybrid cable 1. The sheath 5 surrounds the optical cable 2, the electrical signal cable 3, and the ground wiring 4. The sheath 5 has the generally annular shape in the cross-sectional view. Examples of the material for the sheath 5 include resins. An example of the resin includes a vinyl chloride resin.

### 1.7 Method for Producing Hybrid Cable 1

Next, a method for producing the hybrid cable 1 is described.

In this method, first, each of the optical cable 2, the electrical signal cable 3, and the ground wiring 4 is prepared.

To prepare the electrical signal cable 3, first, as shown in FIG. 2, each of the one pair of differential wirings 31A and 31B, and the shield tape 32 is prepared. To prepare the shield tape 32, the shield layer 322 is film-formed on one surface of the substrate layer 321 in the thickness direction. In the film forming of the shield layer 322, for example, a vacuum film forming method is used. Examples of the vacuum film forming method include vapor deposition, sputtering, and ion plating.

The shield tape 32 is wound spirally around the one pair of differential wirings 31A and 31B so that the substrate layer 321 is brought into contact with the covering material 311, and the shield layer 322 faces outwardly.

Next, the optical cable 2, the electrical signal cable 3, and the ground wiring 4 are assembled and twisted together to be then surrounded by the sheath 5.

### 2. FUNCTION AND EFFECT

In the electrical signal cable 3, the shield layer 322 is disposed at the opposite side of the one pair of differential wirings 31A and 31B with respect to the substrate layer 321. Then, it is possible to bring the shield layer 322 into contact with the ground wiring 4, while providing the ground wiring 4 outside the shield cord. That is, it is possible to dispose the ground wiring 4 away from the one pair of differential wirings 3A and 3B without providing the ground wiring 4 inside the shield tape 32. Therefore, it is possible to suppress attenuation of signals in the one pair of differential wirings 3A and 3B.

In this configuration, it is not necessary to provide the ground wiring 4 inside the shield tape 32. Therefore, it is possible to miniaturize the electrical signal cable 3.

Further, according to the hybrid cable 1, since the shield layer 322 is in contact with the ground wiring 4, it is possible to reliably ground the shield layer 322.

Further, in the hybrid cable 1, since the electrical signal cable 3 and the ground wiring 4 are twisted, it is possible to reliably bring the shield tape 32 of the electrical signal cable 3 into contact with the ground wiring 4.

Further, in the hybrid cable 1, when the twist pitch of the electrical signal cable 3 and the ground wiring 4 is 5 mm or more, it is possible to reduce the pressure on the electrical signal cable 3 by the ground wiring 4. Therefore, it is possible to suppress the damage to the shield tape 32 caused by the entry of the ground wiring 4 into the shield tape 32. Therefore, the electrical signal cable 3 has the excellent reliability of the transmission.

### 3. MODIFIED EXAMPLES

In each modified example below, the same reference numerals are provided for members and steps corresponding to each of those in the above-described one embodiment, and their detailed description is omitted. Further, each modified example can achieve the same function and effect as that of one embodiment unless otherwise specified. Furthermore, one embodiment and each modified example can be appropriately used in combination.

### 3.1 First Modified Example

Although not shown, the hybrid cable 1 further includes a control wiring. The control wiring is surrounded by the sheath 5.

### 3.2 Second Modified Example

The plastic optical fiber 21 is singular.

### 3.3 Third Modified Example

As the shield cord, a shield tube may be also used instead of the shield tape 32. The shield tube has a cylindrical shape or an elliptical cylindrical shape. Specifically, the shield tube has, for example, a single tube shape. Therefore, the shield tube does not include the overlapped portion 32B, and includes only the non-overlapped portion 32A.

On the other hand, in one embodiment, it is possible to easily wind the shield tape 32 around the one pair of differential wirings 31A and 31B.

### 3.4 Fourth Modified Example

The overlapped portion 32B may also include a tripled portion in which the substrate layer 321, the shield layer 322, the substrate layer 321, the shield layer 322, the substrate layer 321, and the shield layer 322 are disposed outwardly in the radial direction. Furthermore, the overlapped portion 32B may be also an n-overlapped portion (n is an integer of 4 or more).

### 3.5 Fifth Modified Example

The electrical signal cable 3 and the ground wiring 4 are not twisted, and each has a straight shape along the direction in which the hybrid cable 1 extends. Preferably, as in one embodiment, the electrical signal cable 3 and the ground wiring 4 are twisted. Thus, it is possible to reliably bring the shield tape 32 of the electrical signal cable 3 into contact with the ground wiring 4.

### 3.6 Sixth Modified Example

The shield tape 32 may also include the substrate layer 321, the shield layer 322, and an intermediate layer disposed between the substrate layer 321 and the shield layer 322. The intermediate layer is, for example, a layer having adhesiveness.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

An electrical signal cable and a hybrid cable of the present invention are preferably used in transmission of signals.

### DESCRIPTION OF REFERENCE NUMERALS

1 Hybrid cable
2 Optical cable
3 Electrical signal cable
3A Differential wiring
3B Differential wiring
4 Ground wiring
5 Sheath
31A Differential wiring
31B Differential wiring
32 Shield tape (one example of shield cord)
321 Substrate layer
322 Sheild layer
P Pitch

1. An electrical signal cable provided in a hybrid cable comprising:
one pair of differential wirings for transmitting electrical signals, and
a shield cord surrounding the one pair of differential wirings and including an insulating substrate layer and a shield layer disposed at the opposite side of the one pair of differential wirings with respect to the substrate layer.

2. A hybrid cable comprising:
the electrical signal cable according to claim 1, and
a ground wiring in contact with the shield layer in the electrical signal cable.

3. The hybrid cable according to claim 2, wherein
the shield cord is a shield tape.

4. The hybrid cable according to claim 2, wherein
the electrical signal cable and the ground wiring are twisted.

5. The hybrid cable according to claim 3, wherein
the electrical signal cable and the ground wiring are twisted.

6. The hybrid cable according to claim 4 further comprising:
an optical cable, and a sheath surrounding the electrical signal cable and the optical cable, wherein
a twist pitch of the optical cable, the electrical signal cable, and the ground wiring is 5 mm or more and 150 mm or less.

7. The hybrid cable according to claim 5 further comprising:
an optical cable, and a sheath surrounding the electrical signal cable and the optical cable, wherein
a twist pitch of the optical cable, the electrical signal cable, and the ground wiring is 5 mm or more and 150 mm or less.
